(19) United States
(12) Patent Application Publication
(10) Pub. No.: US 2026/0187053 A1
(43) Pub. Date: Jul. 2, 2026

(54) AUTOMATED QUERY GENERATION METHOD AND APPARATUS

(71) Applicant: VERIZON PATENT AND LICENSING INC., Basking Ridge, NJ (US)

(72) Inventors: Arun CHERLA, Basking Ridge, NJ (US); Michael HANSON, Alpharetta, GA (US); Allie K. WATFA, Champaign, IL (US); Gopala Krishnan Sankara NARAYANAN, Chennai (IN); Rajender R. NEDNUR, Alpharetta, GA (US); Moorthi SUBBARAYAN, Chapel, FL (US)

(73) Assignee: VERIZON PATENT AND LICENSING INC., Basking Ridge, NJ (US)

(21) Appl. No.: 19/006,687

(22) Filed: Dec. 31, 2024

(51) Int. Cl. G06F 16/242; G06F 40/30

(52) U.S. Cl. CPC G06F 16/242; G06F 40/30

(57) ABSTRACT

Techniques for automatically validating and optimizing structured query generation in connection with a natural language (NL) prompt are disclosed. In one embodiment, a method is disclosed comprising obtaining, by computing device, a natural language (NL) prompt, analyzing, by the computing device, the NL prompt, and determining an expected intent based on the analysis, generating, by the computing device, a query using a structured query generator and the expected intent as input to the structured query generator, the generated query being expressed as a structured query for accessing data at a data source, and analyzing, by the computing device, the generated query and, based on the analysis, make a validation determination indicating whether or not the generated query accurately reflects the expected intent determined for the NL prompt.

### BACKGROUND INFORMATION

Data is commonly stored in data stores that are accessible using a structured query language (SQL) such as that used by a database management system. The level of expertise needed to use a structured query language to access the stored data effectively limits access to the data. Knowledge of the specific syntax and constructs of the query language is needed in order to formulate a query to access the stored data. Natural language processing (NLP) interfaces attempt to bridge the knowledge gap and provide a mechanism for translating natural language input into a structured query. However, these NLP interfaces can produce inaccurate and/or unwanted results.

### BRIEF DESCRIPTION OF THE DRAWINGS

FIG. 1 provides an example illustrating components enabling accurate structured query generation, validation and optimization functionality in accordance with one or more embodiments of the present disclosure;

FIG. 2 provides a table relevance determination process flow in accordance with one or more embodiments of the present disclosure;

FIG. 3 provides an illustrative example of a NL prompt and exemplary data that can be used in determining relevance in accordance with one or more embodiments of the present disclosure;

FIG. 4 provides illustrative examples of an expected intent, query and intent score in connection with an exemplary NL prompt in accordance with one or more embodiments of the present disclosure;

FIG. 5 provides a query generation, validation and optimization process flow in accordance with one or more embodiments of the present disclosure; and

FIG. 6 provides a block diagram illustrating a computing device showing an example of client or server device used in accordance with one or more embodiments of the present disclosure.

### DETAILED DESCRIPTION OF EXAMPLE EMBODIMENTS

Techniques for automatically validating and optimizing structured query generation in connection with a natural language (NL) prompt are disclosed. By way of a non-limiting example, embodiments of the present disclosure can be used in connection with a business intelligence (BI) system. Disclosed embodiments can be used to generate a structured query from a NL prompt. The generated query can be used by the BI system to retrieve data. The BI system can comprise a set of tools, techniques, strategies, etc. to use the retrieved data to perform analytical data processing such as and without limitation predictive and/or prescriptive analytics, provide at-a-glance views of relevant data using a dashboard or other type of graphical user interface, manage business information, etc.

Embodiments disclosed herein can determine an expected intent of the NL prompt, and then use the expected intent to generate a structured query and then validate that the structured query satisfies the expected intent determined for the NL prompt. In accordance with one or more disclosed embodiments, an iterative process can be used to generate a structured query satisfying the expected intent of the NL prompt. In accordance with one or more such embodiments, the iterative process can be used to generate a new structured query using a modified NL prompt in a case that a previously-generated structured query fails to satisfy the expected intent.

In accordance with one or more embodiments, an NL prompt, such as that provided by a user, can be analyzed and an expected intent of the NL prompt can be determined based on the analysis. By way of a non-limiting example, the NL prompt analysis can use natural language processing to identify components of the NL prompt, such as and without limitation a set of entities, a set of filters and a set of relationships. The identified NL prompt components can be used to determine an expected intent of the NL prompt.

In accordance with one or more embodiments, the expected intent can be used by a structured query generator to generate a structured query that can be used for accessing data from at least one data source. By way of some non-limiting examples, the structured query generator can be a large language model (LLM), trained model, deep learning model, etc. Embodiments of the present disclosure can analyze the generated query using the expected intent determined for the NL prompt and, based on the analysis, make a validation determination indicating whether the generated query accurately reflects the expected intent determined for the NL prompt.

In a case where the generated query is determined to accurately reflect the expected intent, embodiments of the present disclosure can cause the generated query to be executed by database engine to access at least one data source. The database engine can generate a set of query results using the generated query, which can be provided as output in response to the NL prompt. By way of a non-limiting example, the database engine can be a database management system (DBMS).

As is discussed in more detail below, where a generated query is determined to inaccurately reflect the expected intent, embodiments of the present disclosure can use an iterative process to generate another structured query. In each iteration of the process, a current NL prompt can be modified and the modified NL prompt can be used to determine an expected intent, which can then be used to generate and validate another structured query. The iterative process can be used to determine an optimal structured query that satisfies a corresponding expected intent. As is discussed below, the generated query can be evaluated using additional criteria, such as and without limiting syntax, schema consistency, data type matching, etc. criteria.

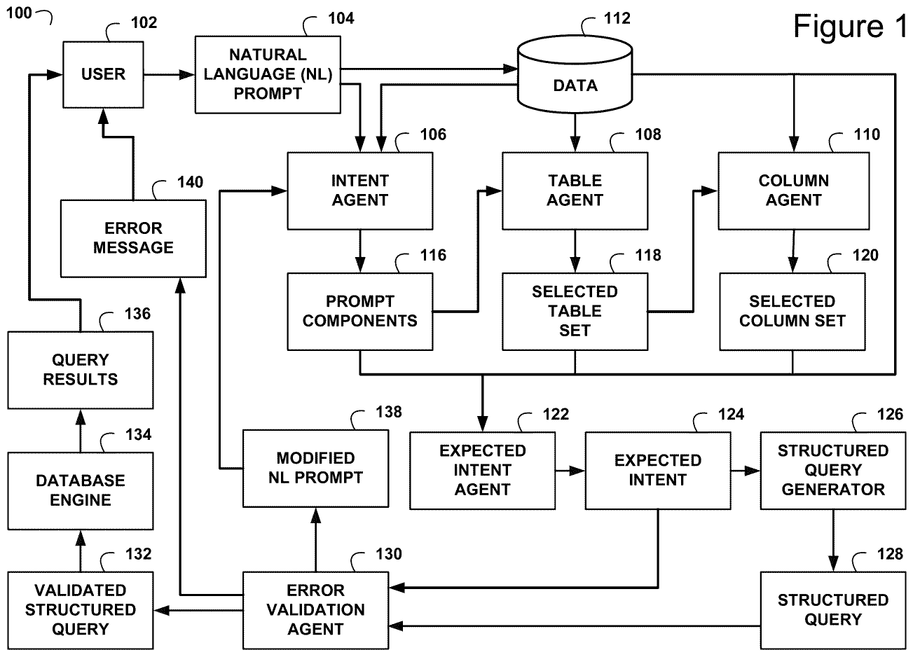

FIG. 1 provides an example illustrating components enabling accurate structured query generation, validation and optimization functionality in accordance with one or more embodiments of the present disclosure. As shown in example 100, NL prompt 104 can be received, or otherwise obtained, from user 102. NL prompt 104 can be provided to intent agent 106, which can use natural language processing (NLP) techniques to decompose NL prompt 104 into prompt components 116. In accordance with one or more embodiments, prompt components 116 can comprise information determined using NL prompt 104, such as and without limitation a set of entities, a set of filters and a set of relationships.

Prompt components 116 can be provided to table agent 108, which can select a set of database tables determined by table agent 108 to correspond to NL prompt 104. In accordance with one or more embodiments, table agent 108 can use data 112 to generate a ranked list of database tables and then select a set of tables—i.e., selected table set 118. By way of some non-limiting examples, data 112 can comprise database schema and metadata information, such as and without limitation tables, columns (or fields) within tables, field data types, table or other entity relationships, supported functions, constraints, etc. Data 112 can further comprise other information, such as and without limitation table size, a count of the number of rows in a table, indexing information, data recency information, etc. Data 112 can further comprise query logs, NL prompt 104 and previous instances of NL prompt 104. Data 112 can further comprise information identifying modifications, or optimizations, made to an instance of NL prompt 104 in accordance with one or more embodiments of the present disclosure. Data 112 can further comprise information identifying an expected intent determined for an instance of NL prompt 104.

In accordance with one or more embodiments, table agent 108 can use data 112 to determine a relevance of some or all of the tables identified in the database schema to the NL prompt 104. Table agent 108 can use the determined relevance of each table to rank the tables and select a set of tables for selected table set 118. Selected table set 118 can include tables that correspond to at least some of the set of entities from prompt components 116 identified by intent agent 106.

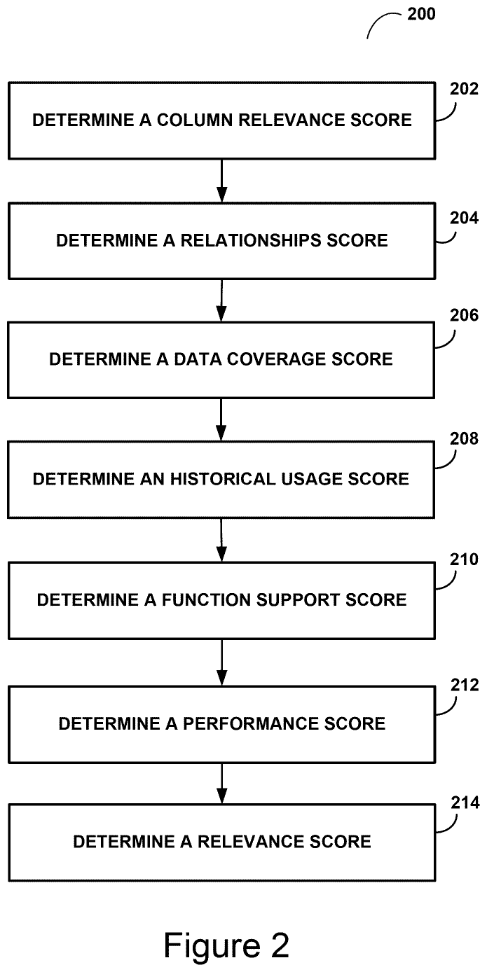

FIG. 2 provides a table relevance determination process flow in accordance with one or more embodiments of the present disclosure. Process flow 200 can be performed by table agent 108. In accordance with one or more embodiments, process flow 200 can be used to determine a relevance of each of table of a set of database tables, from which selected table set 118 can be determined. In accordance with one or more embodiments, table agent 108 can use information from data 112 to determine a relevance score for a respective table. Steps 202-214 of process flow 200 can be performed for each respective table of the set of database tables. Process flow 200 can be used to determine a score for each of a number of relevance factors used to determine a relevance score for each respective table. The relevance score determined for each respective table can be used to rank each respective table in a ranking of the set of database tables, from which selected table set 118 can be determined.

At step 202, a column relevance score can be determined. By way of a non-limiting example, a column relevance score can be determined for a column relevance factor used in determining a relevance score for a respective table using the following exemplary expression:

$$column relevance score = \frac{\vert matched columns \vert}{\vert total columns in table \vert} , \qquad Expr . ( 1 )$$

where the column relevance score can be determined as a ratio of the number of columns, e.g., column names, of the respective table that match information from prompt components 116 to the total number of columns of the respective table.

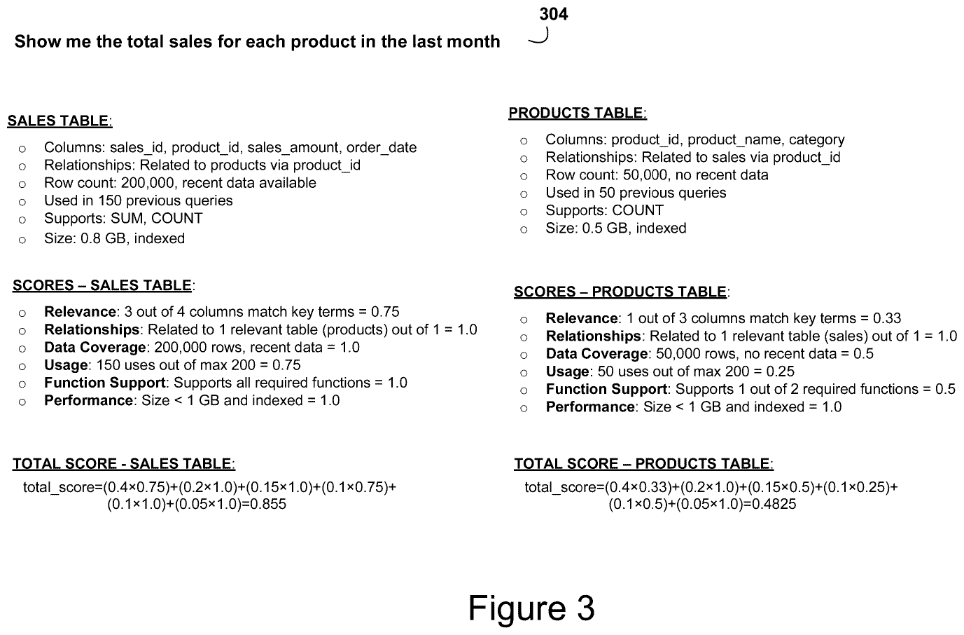

FIG. 3 provides an illustrative example of NL prompt 104 and exemplary data 112 that can be used in determining relevance in accordance with one or more embodiments of the present disclosure. Example 300 includes NL prompt 304, as an example of NL prompt 104, and exemplary data associated with two tables—i.e., a sales table and a products table. In addition, example 300 provides an example illustrating table relevance determinations for the sales and products tables.

Assuming that prompt components 116 include the terms sales, product and month from NL prompt 304, a column relevance score for the sales table can be determined to be 0.74 using Expr (1) based on a determination that the sales_id, sales_amount and order_date columns are identified as corresponding to the terms from prompt components 116. Similarly, a column relevance sore for the products table can be determined to be 0.33 using Expr. (1) based on a determination that the products_name column corresponds to the terms from prompt components 116.

As discussed below, the products_id column in both the sales and products table is a key field that relates the two tables, and its contribution to the relevance of each table is taken into account next, at step 204. At step 204, a relationships score can be determined. By way of a non-limiting example, a relationships score can be determined for a relationship factor used in determining a relevance score for a respective table using the following exemplary expression:

$$relationships score = \frac{\vert matched related tables \vert}{\vert total related tables \vert} , \qquad Expr . ( 2 )$$

where the relationships score can be determined as a ratio of the number of related tables that are relevant to NL prompt 304 to a total number of related tables.

In example 300, the sales table and product tables are related to each other via the product_id key field. Neither table is related to any other table in example 300. Consequently, each table has a relationships score of 1.0.

At step 206, a data coverage score can be determined. By way of a non-limiting example, a data coverage score can be determined for a data coverage factor used in determining a relevance score for a respective table using the following exemplary expression:

$$data coverage score = \{ \begin{matrix}1. & if row count > 100 , 000 and recent data exists \\ 0.75 & if row count > 10 , 000 \\ 0.5 & if row count > 1 , 000 \\ 0.25 & otherwise\end{matrix} , \qquad Expr . ( 3 )$$

where the data coverage score can be determined based on the amount of data the respective table contains and on a recency of the data. The row counts shown in Expr. (3) are exemplary only. It should be apparent that any row count values can be used with embodiments of the present disclosure. In accordance with one or more embodiments, data recency can be determined using a threshold recency, such as and without limitation a recency of one month. It should be apparent that any data recency threshold can be used with embodiments of the present disclosure.

With reference to example 300, the data coverage score for the sales table is 1.0 given that it has recent data and its row count is greater than 1000,000, and the data coverage score for the products table is 0.5 given that no recent data is indicated and its row count is greater than 10,000 but less than 100,000.

At step 208, of FIG. 2, an historical usage score can be determined. By way of a non-limiting example, an historical usage score can be determined for an historical usage factor used in determining a relevance score for a respective table using the following exemplary expression:

$$historical usage score = \frac{\vert table usage count in past queries \vert}{\vert maximum usage count among all tables \vert} , \qquad Expr . ( 4 )$$

where the historical usage score can be determined as a ratio of the frequency, or number of times, that the respective table has been used in a set of past queries over a certain time frame, e.g., the last 30 days, to a maximum usage among all tables.

With reference to example 300, the sales table has a usage score of 0.75 based on a determination that it has been used 150 times and the maximum table usage determined for another table is 200. The usage score of 0.25 can be determined for the products table in a similar manner using Expr. (4).

At step 210, of FIG. 2, a function support score can be determined. By way of a non-limiting example, a function support score can be determined for a function support factor used in determining a relevance score for a respective table using the following exemplary expression:

$$function support score = \frac{\vert matched functions \vert}{\vert required functions \vert} , \qquad Expr . ( 5 )$$

where the function support score for a respective table can be determined as a ratio of a determined number of functions supported by the respective database table to a determined number of functions considered to be needed, or essential, for generating a response to the NL prompt. Some non-limiting examples of functions include without limitation sum, count, avg, etc.

With reference to example 300, the sales table as a function support score of 1.0 given that it supports two functions—i.e., sum and count—and both are required for the NL prompt 304. With respect to the products table, it has a function support score of 0.5 given that it supports 1 of the required functions.

At step 212, of FIG. 2, a performance support score can be determined. By way of a non-limiting example, a performance support score can be determined for a performance support factor used in determining a relevance score for a respective table using the following exemplary expression:

$$performance score = \{ \begin{matrix}1. & if table size < 1 GB and indexes are present \\ 0.75 & if table size < 10 GB \\ 0.5 & if table size < 100 GB \\ 0.25 & otherwise\end{matrix} , \qquad Expr . ( 6 )$$

where the performance score can be determined based on the table size and whether or not the table is indexed, which can provide an indication of how efficiently the table can be queried. The table size values used in Expr. (6) are exemplary only. It should be apparent that any table size values can be used with embodiments of the present disclosure.

With reference to example 300, the performance score for the sales table and the products table is 1.0 given that each one has a table size that is less than 1 gigabyte (GB) and each one is indexed.

At step 214, of FIG. 2, a relevance score can be determined. By way of a non-limiting example, a relevance score can be determined for a respective table using the following exemplary expression:

$$table relevance score = {\sum }_{n = 1} R F {S}_{n} * {w}_{n} , \qquad Expr . ( 7 )$$

where RFSₙ represents the nth relevance factor score and wₙ represents the nth weight corresponding to the nth relevance factor score. Column relevance, relationships, data coverage, historical usage, function support and performance can each be a factor used in determining the relevance score for a respective table. As discussed in connection with steps 202-212, a score can be determined for each relevance factor. Using Expr. (7), the relevance of a respective table can be an aggregate of the relevance factor scores determined for the respective table.

In accordance with one or more embodiments, as illustrated in Expr. (7), each relevance factor's score can be weighted. By way of a non-limiting example, the weight associated with a given relevance factor can indicate a degree of importance of the relevance factor to the respective table's determined relevance score.

By way of a further non-limiting example, column relevance can be considered to be more important that the other relevance factors and be assigned a weight of 40% (or 0.4), followed by the relationships factor having an assigned weight of 20% (or 0.2), followed by the data coverage factor with an assigned weight of 15% (or 0.15), followed by the historical usage and function support factors that each have an assigned a weight of 10% (or 0.10), and followed by the performance factor that has an assigned a weight of 5% (or 0.05). The weights assigned to each relevance factor are exemplary. It should be apparent that any weighting or no weighting at all can be used in accordance with embodiments of the present disclosure.

In example 300, using Expr. (7), the relevance score determined for the sales table is 0.855 and the relevance score determined for the products table is 0.4825. As such, the sales table is ranked higher than the products table and is considered to be more relevant to the NL prompt 304 than the products table. In example 300, both the sales table and the products table are relevant to NL prompt 304, with the sales table being more relevant than the products table. In example 300, table agent 108 can use the relevance scores to rank the tables and then use the table ranking to identify selected table set 118.

Referring again to FIG. 1, selected table set 118 can be provided to column agent 110, which can determine selected column set 120 identifying one or more of the tables from the tables included in selected table set 118. In accordance with one or more embodiments, an initial column set can include each column from each table from the selected table set 118, and column agent 110 can prune, or cull, columns from the initial set to determine selected column set 120. By way of a non-limiting example, column agent 110 can identify columns it considers to store data needed to respond to NL prompt 104, match a column in the set of entities identified in the prompt components 116, match a filter in the set of filters identified in prompt components 116 and/or match a relationship in the set of relationships identified by prompt components 116.

In accordance with one or more embodiments, prompt components 116, selected table set 118, selected column set 120 and data 112 can be used by expected intent agent 122 to determine expected intent 124 based on the input.

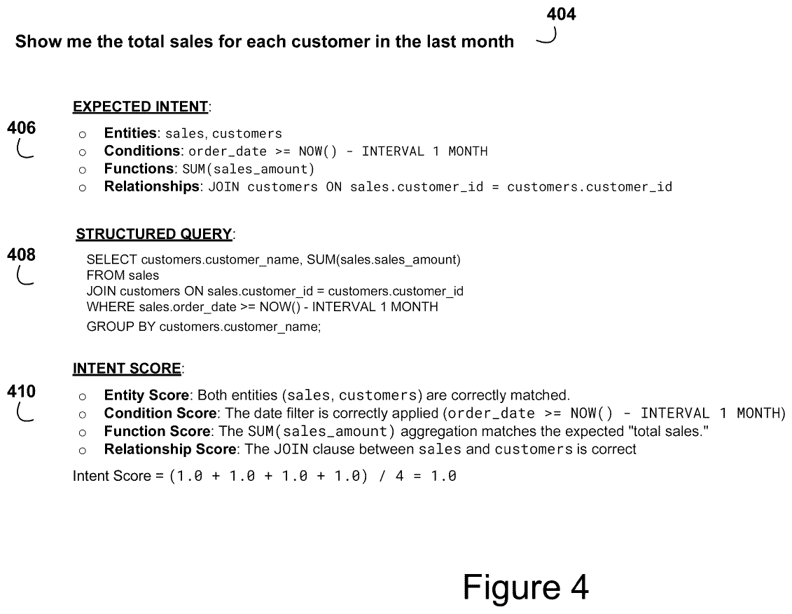

FIG. 4 provides illustrative examples of an expected intent, query and intent score in connection with an exemplary NL prompt in accordance with one or more embodiments of the present disclosure. Example 400 includes NL prompt 404 as another example of NL prompt 104. Expected intent 406 can be determined for NL prompt 104 by expected intent agent 122 using prompt components 116, selected table set 118 and selected column set 120 generated based on an analysis of NL prompt 304. In accordance with one or more embodiments, the analysis can be performed by intent agent 106, table agent 108 and column agent 110.

In example 400, expected intent 406 can include entity information identifying at least some of the tables from selected table set 118. In addition, expected intent 406 can include condition, function and relationship information corresponding to NL prompt 404. In accordance with one or more embodiments, expected intent agent 122 can use the set of filters and the set of relationships from prompt components 116 to determine, respectively, the condition information and the relationship information for expected intent 406.

As discussed, data 112 can include NL prompt 404, which expected intent agent 122 can use to identify one or more of the functions supported by the database tables identified in the entity information that correspond to NL prompt 404.

Referring again to FIG. 1, expected intent 124, 406 determined by expected intent agent 122 can be provided as input to structured query generator 126 and then used by query generator 126 to generate structured query 128. Structured query generator 126 can be a LLM, trained model, deep learning model, etc. With reference to FIG. 4, example 400 includes structured query 408 as an example of a structured query that can be generated by structured query generator 126 using expected intent 406 in accordance with one or more disclosed embodiments.

In accordance with one or more embodiments, expected intent 124 includes database schema information that can be used by structured query generator 126 to generate structured query 128. In one or more disclosed embodiments, while not shown in example 100, structured query generator 126 can access data 112 to retrieve information therefrom for use in generating structured query 128, such as and without limitation, database schema and metadata information, NL prompt 104, etc.

In accordance with one or more embodiments, structured query 128 can be evaluated and validated by error validation agent 130 using expected intent 124. In accordance with one or more embodiments, error validation agent 130 can use expected intent 124 and structured query 128 to generate an intent score that can be used to determine whether structured query 128 accurately reflects the expected intent 124 determined for NL prompt 104. In accordance with one or more embodiments, an intent score can be used by error validation agent 130 to quantify how accurately structured query 128 represents the meaning of NL prompt 104. Error validation agent 130 can use the intent score to validate whether or not structured query 128 was accurately generated by structured query generator 126 for NL prompt 104.

Referring again to FIG. 4, in accordance with one or more embodiments, an intent score, such as intent score 410, can be determined using score determined for each of multiple factors. In accordance with one or more embodiments, the multiple factors can be entity, condition, function and relationship factors and the corresponding scores can be an entity score, condition score, function score and relationship score.

In accordance with one or more embodiments, an entity score can be determined by error validation agent 130 comparing entity information in expected intent 124, 406 with entities used in structured query 128, 408. By way of a non-limiting example, an entity score can be determined for the structured query 128, 408 using the following exemplary expression:

$$entity score = \frac{\vert matched entities \vert}{\vert total entities \vert} , \qquad Expr . ( 8 )$$

where the entity score can be determined as a ratio of the number of correctly matched entities between expected intent 124, 406 and structured query 128, 408. In example 400, expected intent 406 identifies two entities as the total number of entities, and structured query 408 includes, or correctly matches, both of the entities identified in expected intent 406. Thus, using Expr. (8), the entity score used in intent score 410 equals 1.0.

In accordance with one or more embodiments, a condition score can be determined by error validation agent 130 evaluating if the WHERE conditions in structured query 128, 408 correspond with condition information in expected intent 124, 406. By way of a non-limiting example, a condition score can be determined for structured query 128, 408 using the following exemplary expression:

$$condition score = \frac{\vert matched conditions \vert}{\vert total conditions \vert} , \qquad Expr . ( 9 )$$

where the condition score can be determined as a ratio of the number of correctly matched conditions between expected intent 124, 406 and structured query 128, 408. In example 400, expected intent 406 identifies a condition corresponding to a date filter—in the last month—included in the set of filters identified by intent agent 106 in connection with NL prompt 404, and the date filter is correctly applied, or matched, in structured query 128, 408. Thus, using Expr. (9), the condition score used in intent score 410 equals 1.0.

In accordance with one or more embodiments, a function, or aggregation, score can be determined by error validation agent 130 comparing the function information identified in expected intent 124, 406 with each function used in structured query 128, 408. By way of a non-limiting example, a function score can be determined for structured query 128, 408 using the following exemplary expression:

$$function score = \frac{\vert matched funcitons \vert}{\vert total functions \vert} , \qquad Expr . ( 10 )$$

where the function score can be determined as a ratio of the number of functions used in structured query 128, 408 that match functions identified in expected intent 124, 406 to the total number of functions identified in expected intent 124, 406. In example 400, expected intent 406 identifies a SUM function which matches the SUM function used in structured query 128, 408. Thus, using Expr. (10), the function score used in intent score 410 equals 1.0.

In accordance with one or more embodiments, a relationship score can be determined by error validation agent 130 comparing the relationship information identified in expected intent 124, 406 with each relationship used in structured query 128, 408. By way of a non-limiting example, a relationship score can be determined for the structured query 128, 408 using the following exemplary expression:

$$relationship score = \frac{\vert matched relationships \vert}{\vert total relationships \vert} , \qquad Expr . ( 11 )$$

where the function score can be determined as a ratio of the number of relationships used in structured query 128, 408 that match relationships identified in expected intent 124, 406 to the total number of relationships identified in expected intent 124, 406. In example 400, expected intent 406 identifies a relationship between the sales and customers tables via the customer_id key field which matches the relationship used in the JOIN clause in structured query 128, 408. Thus, using Expr. (11), the relationships score used in intent score 410 equals 1.0.

In accordance with one or more embodiments, error validation agent 130 can aggregate the determined intent, condition, function and relationship scores to determine an intent score for structured query 128, 408. Error validation agent 130 can use the determined intent score to evaluate and validate whether or not structured query 128, 408 accurately reflects, or matches, the intent of NL prompt 104, 404, which intent is expressed as expected intent 124, 406. By way of a non-limiting example, an intent score that satisfies a threshold number, such as 1, can indicate that the structured query 128, 408 does reflect, or match, the intent of NL prompt 104, 404, and an intent score that fails to satisfy the threshold, such as an intent score that is less than 1, can be determined to not reflect, or match, the intent of NL prompt 104, 404.

With reference to FIG. 1, in accordance with one or more embodiments, a structured query 128 validated by error validation agent 130, such as validated structured query 132, can be submitted to database engine 134, query results 136 can be generated by database engine 134 using validated structured query 132, and the generated query results 136 can be provided to user 102 in response to NL prompt 104.

In accordance with one or more embodiments, error validation agent 130 can evaluate and validate structured query 128 using other criteria in addition to intent score. By way of a non-limiting example, error validation agent 130 can perform syntax validation to evaluate whether or not structured query 128 uses a syntax that would prevent it from being executed by database engine 134. By way of some non-limiting examples, error validation agent 130 can use a SQL parser or other syntax validation tool (e.g., pgAdmin®, SQLAlchemy®, etc.), to check whether or not execution of structured query 128 is likely to raise a syntax error.

By way of another non-limiting example, error validation agent 130 can perform schema consistency validation to evaluate whether or not structured query 128 correctly maps to a database's schema. By way of a further non-limiting example, the schema consistency validation can be used to ensure that all of the tables, columns, functions and/or relationships referenced in structured query 128 are consistent with database schema information.

Another non-limiting example of validation that can be performed by error validation agent 130 is type checking and function validation to evaluate whether or not a column is correctly used in a function, or other operator, based on its data type. By way of a further non-limiting example, error validation agent 130 can ensure that a SUM function is being used with a column that has a numeric data type.

Another non-limiting example of validation that can be performed by error validation agent 130 is logical validation, which can be used to evaluate whether or not conditions in a WHERE clause of structured query 128 match NL prompt 104. By way of a non-limiting example, error validation agent 130 can ensure that a GROUP BY statement is being properly used in the WHERE clause based on the NL prompt 104. By way of a further non-limiting example, logical validation can involve verifying that a function, such as AVG, matches NL prompt 104.

Another non-limiting example of validation that can be performed by error validation agent 130 is data coverage validation, which can involve comparing an expected result structure (e.g., columns, data types, number of rows, etc.) with actual output (e.g., query results 136) after executing structured query 128. By way of a non-limiting example, in a case where NL prompt 104 requests that the results be grouped by month, data coverage validation can be used to ensure that structured query 128 generates a correct number of groups and that the time interval matches the requested time interval.

Another non-limiting example of validation that can be performed by error validation agent 130 involves performance and resource validation. Error validation agent 130 can examine the execution plan that is to be used to execute structured query 128 to detect potential performance bottlenecks, such as and without limitation full table scans, improper indexing, etc. Error validation agent 130 can detect and handle issues such as timeouts, memory overflows, etc. that can be due to large data processing. By way of a non-limiting example, error validation agent 130 can address a potential lengthy query execution can be optimized by validating the use of indexes, partitioning or limiting result size using LIMIT clauses.

In accordance with one or more embodiments, error validation agent 130 can address a structured query 128 that it determines cannot be remedied using an iterative process by providing user 102 with an error message 140.

In a case where error validation agent 130 considers, based on its evaluation of structured query 128, that NL prompt 104 can be modified to address one or more reasons for invalidating structured query 128, error validation agent 130 can generate modified NL prompt 138. In accordance with one or more embodiments, modified NL prompt 138 can be submitted in a current iteration of the iterative process to generate a validated structured query 132. In accordance with one or more embodiments, modified NL prompt 138 can be used in place of NL prompt 104 to generate another structured query 128, which can be validated by error validation agent 130.

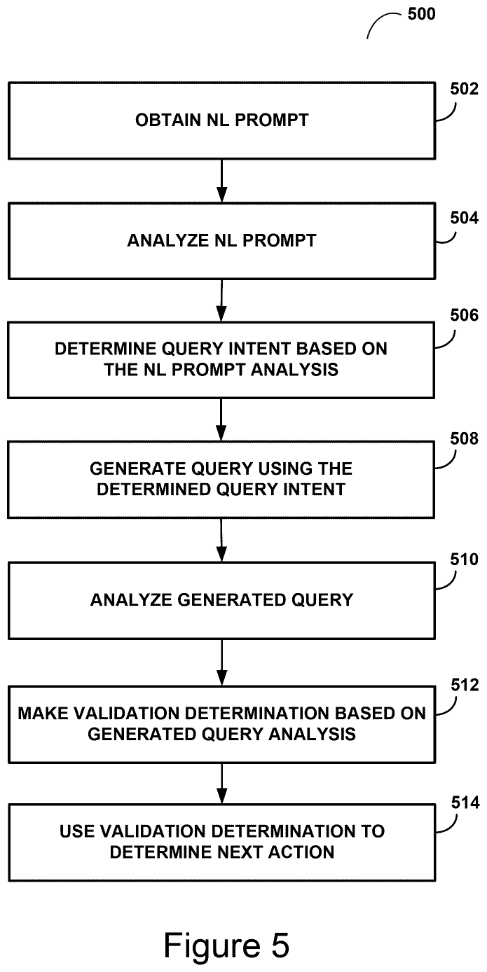

FIG. 5 provides a query generation, validation and optimization process flow in accordance with one or more embodiments of the present disclosure. Process flow 500 can be performed by intent agent 106, table agent 108, column agent 110, expected intent agent 122, structured query generator 126 and error validation agent 130. In accordance with one or more embodiments, process flow 500 can be used to analyze NL prompt 104 and determine an expected intent 124 for NL prompt 104, which can then be used to generate and validate structured query 128.

At step 502, a NL prompt can be obtained. By way of a non-limiting example, NL prompt 104 can be obtained from user 102.

At step 504, the NL prompt can be analyzed. By way of a non-limiting example, step 504 can be performed by intent agent 106, table agent 108, and column agent 110. Intent agent 106 can analyze NL prompt 104 and generate prompt components 116 based on the analysis. Table agent 108 can use prompt components 116 to rank database tables based on relevance and to generate selected table set 118 based on the ranking. Column agent 110 can identify columns from tables included in the selected table set 118 and generate selected column set 120 comprising a set of columns from the tables included in the selected table set 118.

At step 506, a query intent can be determined based on the NL prompt analysis. By way of a non-limiting example, step 506 can be performed by expected intent agent 122. Expected intent agent 122 can use prompt components 116, selected table set 118, selected column set 120, NL prompt 104 and data 112 to determine expected intent 124 for NL prompt 104.

At step 508, a query can be generated using the determined query intent. By way of a non-limiting example, step 508 can be performed by structured query generator 126 using expected intent 124 determined for NL prompt 104. Structured query generator 126 can generate a query that is expressed as structured query, such as structured query 128, which can be used for accessing data at a data source.

At step 510, the generated query can be analyzed. By way of a non-limiting example, step 510 can be performed by error validation agent 130. By way of a further non-limiting example, error validation agent 130 can evaluate structured query 128 based on an intent score that it can generate using expected intent 124 and structured query 128. As discussed, error validation can evaluate and validate structured query 128 using other criteria in addition to its evaluation using a determined intent score.

At step 512, a validation determination can be made based on analysis of the generated query. By way of a non-limiting example, step 512 can be performed by error validation agent 130. At step 514, a next action can be determined using the validation determination. By way of a non-limiting example, step 514 can be performed by error validation agent 130. Error validation agent 130 can use the validation determination made at step 512 to determine whether to cause database engine 134 to execute the structured query 128 in a case that its validation determination indicates that structured query generator 126 generated validated structured query 132.

As discussed, where error validation agent 130 determines that structured query 128 fails to accurately reflect expected intent 124 determined for NL prompt 104, error validation agent 130 can use an iterative process involving one or more iterations. In a given iteration, error validation agent 130 can generate a modified NL prompt 138, which can be used to generate expected intent 124 corresponding to modified NL prompt 138, and the corresponding expected intent 124 can be used to generate and validate another structured query 128.

By way of a further non-limiting example, error validation agent 130 can use the validation determination to generate error message 140 for the user in response to NL prompt 104. By way of a non-limiting example, error message 140 may be generated by error validation agent 130 in a case that an expected intent 124 cannot be determined for NL prompt 104 and/or a valid query cannot be generated in connection with NL prompt 104.

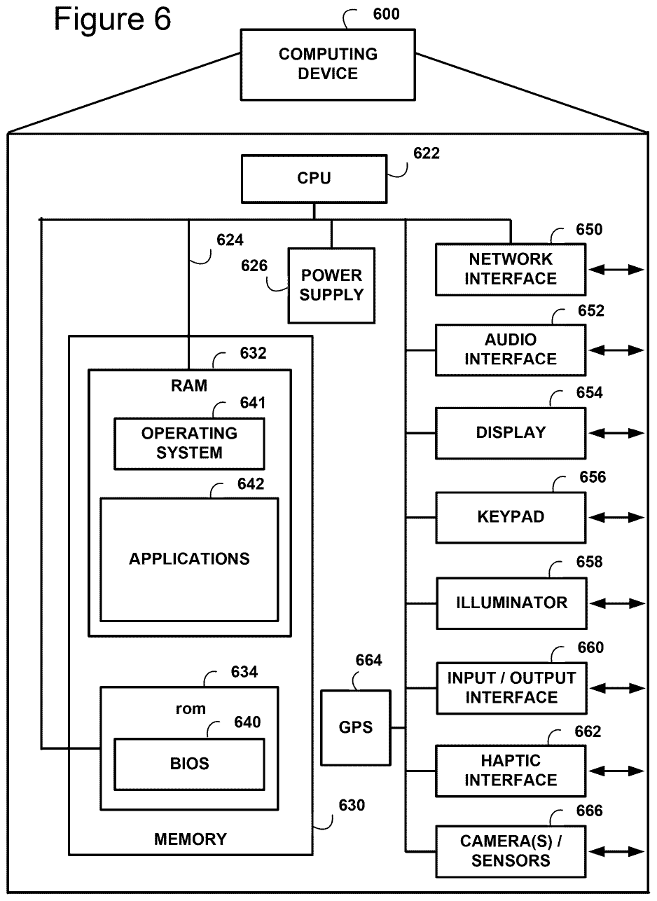

FIG. 6 is a block diagram illustrating a computing device showing an example of a client or server device that can be used to implement functionality described in connection with various embodiments of the disclosure.

The computing device 600 may include more or fewer components than those shown in FIG. 6, depending on the deployment or usage of the device 600. For example, a server computing device, such as a rack-mounted server, may not include audio interfaces 652, displays 654, keypads 656, illuminators 658, haptic interfaces 662, GPS receivers 664, or cameras/sensors 666. Some devices may include additional components not shown, such as graphics processing unit (GPU) devices, cryptographic co-processors, artificial intelligence (AI) accelerators, or other peripheral devices.

As shown in FIG. 6, the device 600 includes a central processing unit (CPU) 622 in communication with a mass memory 630 via bus 624. The computing device 600 also includes one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal, or electromagnetic sensors 666, and power supply 626. Device 600 can include one camera/sensor 666 or a plurality of cameras/sensors 666. The positioning of the camera(s)/sensor(s) 666 on the device 600 can change per device 600 model, per device 600 capabilities, and the like, or some combination thereof.

In some embodiments, the CPU 622 may comprise a general-purpose CPU. The CPU 622 may comprise a single-core or multiple-core CPU. The CPU 622 may comprise a system-on-a-chip (SoC) or a similar embedded system. In some embodiments, a GPU may be used in place of, or in combination with, a CPU 622. Mass memory 630 may comprise a dynamic random-access memory (DRAM) device, a static random-access memory device (SRAM), or a Flash (e.g., NAND Flash) memory device. In some embodiments, mass memory 630 may comprise a combination of such memory types. In one embodiment, the bus 624 may comprise a Peripheral Component Interconnect Express (PCIe) bus. In some embodiments, the bus 624 may comprise multiple busses instead of a single bus.

Mass memory 630 illustrates another example of computer storage media for the storage of information such as computer-readable instructions, data structures, program modules, or other data. Mass memory 630 stores a basic input/output system (“BIOS”) 640 (e.g., as part of ROM 634) for controlling the low-level operation of the computing device 600. The mass memory also stores an operating system 641 for controlling the operation of the computing device 600.

Applications 642 may include computer-executable instructions which, when executed by the computing device 600, perform any of the methods (or portions of the methods) described previously in the description of the preceding Figures. In some embodiments, the software or programs implementing the method embodiments can be read from a hard disk drive (not illustrated) and temporarily stored in RAM 632 by CPU 622. CPU 622 may then read the software or data from RAM 632, process them, and store them to RAM 632 again.

The computing device 600 may optionally communicate with a base station (not shown) or directly with another computing device. Network interface 650 is sometimes known as a transceiver, transceiving device, or network interface card (NIC).

The audio interface 652 produces and receives audio signals such as the sound of a human voice. For example, the audio interface 652 may be coupled to a speaker and microphone (not shown) to enable telecommunication with others or generate an audio acknowledgment for some action. Display 654 may also include a touch-sensitive screen arranged to receive input from an object such as a stylus or a digit from a human hand.

Keypad 656 may comprise any input device arranged to receive input from a user. Illuminator 658 may provide a status indication or provide light.

The computing device 600 also comprises an input/output interface 660 for communicating with external devices, using communication technologies, such as USB, infrared, Bluetooth™, or the like. The haptic interface 662 provides tactile feedback to a user of the client device.

The optional GPS transceiver 664 can determine the physical coordinates of the computing device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS, or the like, to further determine the physical location of the computing device 600 on the surface of the Earth. In one embodiment, however, the computing device 600 may communicate through other components, provide other information that may be employed to determine a physical location of the device, including, for example, a MAC address, IP address, or the like.

The present disclosure has been described with reference to the accompanying drawings, which form a part hereof, and which show, by way of a non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and,” “or,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer-readable medium (or computer-readable storage medium/media) stores computer data, which data can include computer program code (or computer-executable instructions) that is executable by a computer, in machine-readable form. By way of example, and not limitation, a computer-readable medium may comprise computer-readable storage media, for tangible or fixed storage of data, or communication media for transient interpretation of code-containing signals. Computer-readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer-readable storage media can tangibly encode computer-executable instructions that when executed by a processor associated with a computing device perform functionality disclosed herein in connection with one or more embodiments.

Computer-readable storage media includes, but is not limited to, RAM, ROM, EPROM, EEPROM, flash memory or other solid-state memory technology, CD-ROM, DVD, or other optical storage, cloud storage, magnetic storage devices, or any other physical or material medium which can be used to tangibly store thereon the desired information or data or instructions and which can be accessed by a computer or processor.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user,” “subscriber,” “consumer,” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

1. A method comprising:
obtaining, by computing device, a natural language (NL) prompt;
analyzing, by the computing device, the NL prompt, and determining an expected intent based on the analysis;
generating, by the computing device, a query using a structured query generator and the expected intent as input to the structured query generator, the generated query being expressed as a structured query for accessing data at a data source; and
analyzing, by the computing device, the generated query and, based on the analysis, making a validation determination indicating whether or not the generated query accurately reflects the expected intent determined for the NL prompt.

2. The method of claim 1, wherein generating a query further comprises:
generating, by computing device, the query using a large language model (LLM) as the structured query generator, the LLM using the expected intent to generate the structured query.

3. The method of claim 1, further comprising:
causing, by computing device, the generated query to be executed by the data source based on the validation determination indicating that the generated query accurately reflects the expected intent determined for the NL prompt.

4. The method of claim 1, further comprising:
modifying, by the computing device, the NL prompt based on the validation determination indicating that the generated query is an inaccurate reflection of the expected intent determined for the NL prompt; and
performing, by the computing device, the NL prompt analysis, structured query generation, generated query analysis and query execution determination based on the modified NL prompt.

5. The method of claim 1, the NL prompt analysis further comprising:
analyzing, by the computing device, the NL prompt using NL processing (NLP), and identifying a set of entities, a set of filters and a set of relationships based on the NL prompt analysis.

6. The method of claim 5, further comprising:
determining, by the computing device, using database entity and metadata information, database schema information, query logs and the NL prompt, a relevance of each database table of a plurality of database tables to the NL prompt;
ranking, by the computing device, the plurality of database tables based on relevance of each database table to the NL prompt; and
selecting, by the computing device, from a ranked listing of the plurality of database tables, a set of database tables corresponding to the NL prompt.

7. The method of claim 1, determining a relevance of each database table further comprising:
determining, by the computing device, for a respective database table, a column relevance score based on a number of columns of the respective database table that match information from analyzing the NL prompt and a total number of columns of the respective database table;
determining, by the computing device, for the respective database table, a relationships score based on a number of related database tables that are relevant to the NL prompt and a total number of related database table;
determining, by the computing device, for the respective database table, a data coverage score based on an amount of data contained in the respective database table and a recency of the data contained in the respective database table;
determining, by the computing device, for the respective database table, a historical usage score based on a frequency that the respective database table has been used in a set of past queries;
determining, by the computing device, for the respective database table, a function support score based on number of query function needed for generating a response to the NL prompt that are supported by the respective database table;
determining, by the computing device, for the respective database table, a performance score based on a size of the respective table and whether there is any indexing associated with the respective database table; and
determining, by the computing device, a relevance score indicating the relevance of the respective database table based on the determined column relevance, relationships, data coverage, historical usage, function support, and performance scores.

8. The method of claim 7, determining a relevance score further comprising:
determining, by the computing device, the relevance score indicating the relevance of the respective database table based on the determined column relevance, relationships, data coverage, historical usage, function support, and performance scores and a respective weighting associated with each of the scores.

9. The method of claim 1, analyzing the generated query further comprising:
analyzing, by the computing device, the generated query and identifying any syntax errors in the generated query;
analyzing, by the computing device, the generated query and identifying any schema errors associated with the generated query;
analyzing, by the computing device, the generated query and identifying any data type mismatches associated with the generated query;
analyzing, by the computing device, the generated query and identifying any conditional mismatches between the NL prompt and the generated query; and
making the validation determination in accordance with any identified syntax errors, schema errors, data type mismatches and conditional mismatches.

10. The method of claim 1, analyzing the generated query further comprising:
causing, by the computing device, the generated query to be executed by a data source prior to making the validation determination; and
analyzing, by the computing device, results produced by the execution of the generated query and making, as part of the validation determination, a data coverage validation determination indicating whether the results produced by the query match results expected in connection with the NL prompt.

11. The method of claim 1, analyzing the generated query further comprising:
obtaining, by the computing device, from a data source a query execution plan; and
analyzing, by the computing device, the query execution plan for any performance issues associated with execution of the query.

12. The method of claim 1, analyzing the generated query further comprising:
performing, by the computing device, a multi-factor analysis in connection with the generated query, and determining, based on the multi-factor analysis, an intent score indicating a degree to which the generated query reflects the expected intent determined for the NL prompt; and
making the validation determination using the determined intent score.

13. The method of claim 12, performing a multi-factor analysis further comprising:
determining, by the computing device, based on the multi-factor analysis, a respective score for each of multiple factors; and
determining, by computing device, the intent score using the respective score of each of the multiple factors.

14. The method of claim 13, determining a respective score for each of multiple factors further comprising:
analyzing, by the computing device, the NL prompt and determining a set of entities in connection with the NL prompt based on the analysis;
analyzing, by the computing device, the generated query and determining a set of entities in connection with the generated query based on the analysis;
determining, by the computing device, a number of matching entities found in both the set of NL prompt entities and the set of generated query entities;
determining, by the computing device, a total number of entities in both the set of NL prompt entities and the set of generated query entities; and
determining, by the computing device, an entity score based on the determined number of matching entities and the determined total number of entities.

15. The method of claim 13, determining a respective score for each of multiple factors further comprising:
analyzing, by the computing device, the NL prompt and determining a set of conditions in connection with the NL prompt based on the analysis;
analyzing, by the computing device, the generated query and determining a set of conditions in connection with the generated query based on the analysis;
determining, by the computing device, a number of matching conditions found in both the set of NL prompt conditions and the set of generated query conditions;
determining, by the computing device, a total number of conditions in both the set of NL prompt conditions and the set of generated query conditions; and
determining, by the computing device, a condition score based on the determined number of matching conditions and the determined total number of conditions.

16. The method of claim 13, determining a respective score for each of multiple factors further comprising:
analyzing, by the computing device, the NL prompt and determining a set of functions in connection with the NL prompt based on the analysis;
analyzing, by the computing device, the generated query and determining a set of functions in connection with the generated query based on the analysis;
determining, by the computing device, a number of matching functions found in both the set of NL prompt functions and the set of generated query functions;
determining, by the computing device, a total number of functions in both the set of NL prompt functions and the set of generated query functions; and
determining, by the computing device, a function score based on the determined number of matching functions and the determined total number of functions.

17. The method of claim 13, determining a respective score for each of multiple factors further comprising:
analyzing, by the computing device, the NL prompt and determining a set of entity relationships in connection with the NL prompt based on the analysis;
analyzing, by the computing device, the generated query and determining a set of entity relationships in connection with the generated query based on the analysis;
determining, by the computing device, a number of matching entity relationships found in both the set of NL prompt entity relationships and the set of generated query entity relationships;
determining, by the computing device, a total number of entity relationships in both the set of NL prompt entity relationships and the set of generated query entity relationships; and
determining, by the computing device, a relationship score based on the determined number of matching entity relationships and the determined total number of entity relationships.

18. A non-transitory computer-readable storage medium tangibly encoded with computer-executable instructions that when executed by a processor associated with a computing device perform a method comprising:
obtaining a natural language (NL) prompt;
analyzing the NL prompt, and determining an expected intent based on the analysis;
generating a query using a structured query generator and the expected intent as input to the structured query generator, the generated query being expressed as a structured query for accessing data at a data source; and
analyzing the generated query and, based on the analysis, making a validation determination indicating whether or not the generated query accurately reflects the expected intent determined for the NL prompt.

19. The non-transitory computer-readable storage medium of claim 18, wherein generating a query further comprises:
generating, the query using a large language model (LLM) as the structured query generator, the LLM using the expected intent to generate the structured query.

20. A device comprising:
a processor, configured to:
obtain a natural language (NL) prompt;
analyze the NL prompt, and determining an expected intent based on the analysis;
generate a query using a structured query generator and the expected intent as input to the structured query generator, the generated query being expressed as a structured query for accessing data at a data source; and
analyze the generated query and, based on the analysis, make a validation determination indicating whether or not the generated query accurately reflects the expected intent determined for the NL prompt.
